(19) United States
(12) Patent Application Publication
(10) Pub. No.: US 2017/0308948 A1
(43) Pub. Date: Oct. 26, 2017

(54) ELECTRIFIED VEHICLE ACTIVITY CENTER RANKING

(71) Applicant: FORD GLOBAL TECHNOLOGIES, LLC, Dearborn, MI (US)

(72) Inventors: Satish B. Chikkannanavar, Canton, MI (US); Venkataramani Anandan, Farmington Hills, MI (US); Kwaku O. Prakah-Asante, Commerce Twp., MI (US)

(21) Appl. No.: 15/137,046

(22) Filed: Apr. 25, 2016

(51) Int. Cl. G06Q 30/06; G06F 17/30; G01C 21/36; B60L 11/18

(52) U.S. Cl. CPC G06Q 30/0631; G06F 17/30554; B60L 11/1816; G01C 21/3679; G06F 17/3053

(57) ABSTRACT

An exemplary activity center ranking method includes ranking a plurality of activity centers based on what activity centers were visited in connection with previous charges, and communicating at least one of the plurality of activity centers to an operator of an electrified vehicle based on the ranking and proximity to the charging station.

### TECHNICAL FIELD

This disclosure relates generally to ranking activity centers near a charging station. Higher ranked activity centers are prioritized for communication to an operator of an electrified vehicle ahead of lower ranked activity centers.

### BACKGROUND

Electrified vehicles differ from conventional motor vehicles because electrified vehicles are selectively driven using one or more electric machines powered by a battery. The electric machines can drive the electrified vehicles instead of, or in addition to, an internal combustion engine. Example electrified vehicles include hybrid electric vehicles (HEVs), plug-in hybrid electric vehicles (PHEVs), fuel cell vehicles (FCVs), and battery electric vehicles (BEVs).

Many electrified vehicles charge the battery at a charging station. Some electrified vehicles can identify nearby charging stations.

### SUMMARY

An activity center ranking method according to an exemplary aspect of the present disclosure includes, among other things, ranking a plurality of activity centers based on what activity centers were visited in connection with previous charges, and communicating at least one of the plurality of activity centers to an operator of an electrified vehicle based on the ranking and proximity to a charging station.

In a further non-limiting embodiment of the foregoing method, the method includes comprising receiving a selection of one of the plurality of activity centers, and planning a route for the electrified vehicle from the charging station to the one of the plurality of activity centers.

In a further non-limiting embodiment of any of the foregoing methods, the method includes ranking the plurality of activity centers based additionally on a driving history of the operator.

In a further non-limiting embodiment of any of the foregoing methods, the method includes ranking the plurality of activity centers based additionally on a profile of the operator.

In a further non-limiting embodiment of any of the foregoing methods, the method includes communicating the at least one activity center using a display.

In a further non-limiting embodiment of any of the foregoing methods, the method includes communicating the at least one activity center using an audible alert.

In a further non-limiting embodiment of any of the foregoing methods, the method includes ranking the plurality of activity centers based on what activity centers were visited by the operator during previous charges of the electrified vehicle.

In a further non-limiting embodiment of any of the foregoing methods, the method includes ranking the plurality of activity centers based on what activity centers were visited during a threshold time period after previous charges of the electrified vehicle.

In a further non-limiting embodiment of any of the foregoing methods, the method includes ranking the plurality of activity centers based on what activity centers were visited by the operator in connection with previous charges of another electrified vehicle.

In a further non-limiting embodiment of any of the foregoing methods, the method includes ranking the plurality of activity centers based on what activity centers were visited in connection with previous charges of the electrified vehicle.

In a further non-limiting embodiment of any of the foregoing methods, the charging station is a charging station that has not previously charged the electrified vehicle.

In a further non-limiting embodiment of any of the foregoing methods, the ranking is based on a frequency of visits to a type of activity center.

In a further non-limiting embodiment of any of the foregoing methods, the ranking is additionally based on a profile of the operator.

An electrified vehicle system according to an exemplary aspect of the present disclosure includes, among other things, an activity center ranking control system configured to execute a program that ranks a plurality of activity centers based on activity centers visited in connection with charges of an electrified vehicle, and an activity center reporting device configured to communicate at least one of the activity centers based on the ranking and proximity to a charging station used to charge the electrified vehicle.

In a further non-limiting embodiment of the foregoing system, the activity center reporting device comprises a display within the electrified vehicle.

In a further non-limiting embodiment of any of the foregoing systems, the program further ranks the plurality of activity centers based on an operator of the electrified vehicle.

In a further non-limiting embodiment of any of the foregoing systems, the program further ranks the plurality of activity centers based on what activity centers were visited by the operator during previous charges of the electrified vehicle.

In a further non-limiting embodiment of any of the foregoing systems, the program further ranks the plurality of activity centers based on what activity centers were visited during a threshold time period after previous charges of the electrified vehicle.

In a further non-limiting embodiment of any of the foregoing systems, the program further ranks based on what activity centers were visited by the operator in connection with previous charges of another electrified vehicle.

In a further non-limiting embodiment of any of the foregoing systems, the charging station is a charging station that has not previously charged the electrified vehicle.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 shows a highly schematic view of an example electrified vehicle and charging station.

FIG. 2 shows a user interface display from the electrified vehicle of FIG. 1.

FIG. 3 shows a flowchart of an example method used in connection with a control system of the electrified vehicle of FIG. 1.

FIG. 4 shows a flowchart of another example process used within the method of FIG. 3.

FIG. 5 shows a flowchart of another example method used in connection with the control system of the electrified vehicle of FIG. 3.

### DETAILED DESCRIPTION

This disclosure relates generally to ranking activity centers for an operator of an electrified vehicle. The ranking helps ensure that the activity centers most relevant to the operator are communicated to the operator. The operator can review the activity centers when, for example, charging the electrified vehicle at a charging station. The ranking of the activity centers can be based on activity centers visited by the operator in connection with past charges of the electrified vehicle. During charging the operator may visit the activity centers nearby. For example, the operator could walk from the vehicle to one or more of the activity centers while the vehicle is charging. Alternatively, after charging the electrified vehicle, the operator may choose to drive the electrified vehicle to one of the activity centers.

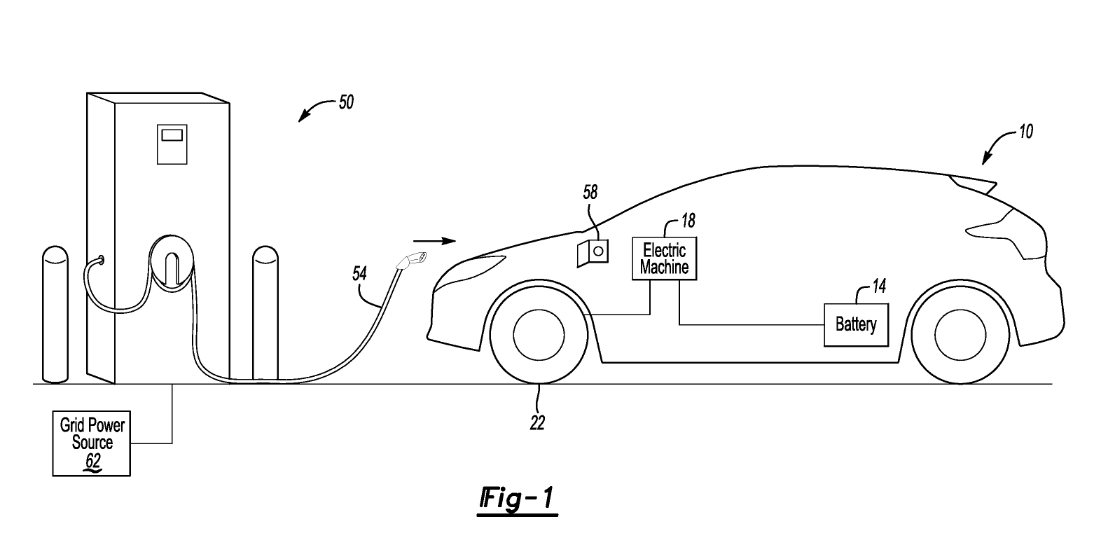

Referring to FIG. 1, an example electrified vehicle 10 includes a battery 14, an electric machine 18 and a pair of wheels 22. The electric machine 18 can receive electric power from the battery 14. The electric machine 18 converts the electric power to torque that drives the wheels 22. The battery 14 is relatively high voltage traction battery in some embodiments.

The example electrified vehicle 10 is an all-electric vehicle. In other examples, the electrified vehicle 10 is a hybrid electric vehicle, which can selectively drive the wheels 22 with torque provided by an internal combustion engine instead of, or in addition to, the electric machine.

The battery 14 may periodically require recharging. A charging station 50 can provide power to recharge the battery 14. The charging station 50 includes a cord set 54 that can engage a port 58 of the electrified vehicle 10 to electrically couple the electrified vehicle 10 to the charging station 50. When the electrified vehicle 10 and the charging station 50 are electrically coupled, power can move from a grid power source 62 to the electrified vehicle 10. The power from the grid power source 62 recharges the battery 14. Recharging the battery 14 can take time.

The example electrified vehicle 10 provides information to an operator of the electrified vehicle 10 when the electrified vehicle 10 is on the way to, or at, the charging station 50. The information includes, among other things, activity centers. The activity centers are ranked so that the activity centers communicated to the operator can be prioritized for the operator. For example, a more highly ranked activity center can be communicated to the operator rather than, or before, a lower ranked activity center.

Known systems can display activity centers, but the displayed activity centers are not ranked based on what activity centers were visited in connection with previous charges.

In contrast to the known systems, the exemplary electrified vehicle 10 can communicate activity centers to the operator, and the activity centers are ranked based on what activity centers were visited in connection with previous charges. Ranking the activity centers in this way helps to ensure that the operator is presented with activity centers near the charging station 50 that may be of interest to the operator. The activity centers are generally any places of activity for the driver. The activity centers could include, for example, a coffee shop, shopping mall, fitness center, public library, book store, entertainment location, public library, grocery story, beauty salon, florist, spa, art fair, etc. The activity centers can be expanded over time as the operator drives the electrified vehicle 10 and visits more and more activity centers.

The proximity of the electrified vehicle 10 to the charging station 50 is detected, and, in response, ranked activity centers associated with the charging station 50 are communicated to the operator. The activity centers can be communicated to the operator in connection with a charge of the electrified vehicle 10 at the charging station 50. The operator could review the activity centers when charging the battery 14 at the charging station 50, or when the electrified vehicle 10 is located at the charging station 50 but not actively charging. The operator could then walk to one or more of the activity centers while the electrified vehicle 10 is charging. This helps to occupy the operator during the charging. The operator could instead, or additionally, drive the electrified vehicle 10 to one or more of the activity centers near the charging station 50 after charging the electrified vehicle 10.

The operator could also review the activity centers when charging the battery 14 is required or requested, but the electrified vehicle 10 is not close to any charging station. For example, the operator can receive a notification that charging the battery 14 is required when the operator is driving the electrified vehicle 10. In response, the operator could review a few different charging stations and their associated activity centers. The activity center review can help the operator choose which charging station to use. As an example, the operator may want coffee before or after charging the electrified vehicle 10. The operator thus selects a charging station having a coffee shop nearby.

The charging stations situated along a given route travelled by the operator driving the electrified vehicle 10 are thus associated with activity center rankings that are customized to the operator. The activity center rankings may persuade the operator to charge the battery 14 at the charging station 50 instead of some other charging station along the route. The customization refers to the ranking process, which ranks the activity centers based on tracking behavior of the operator during previous drives, previous charges, or both.

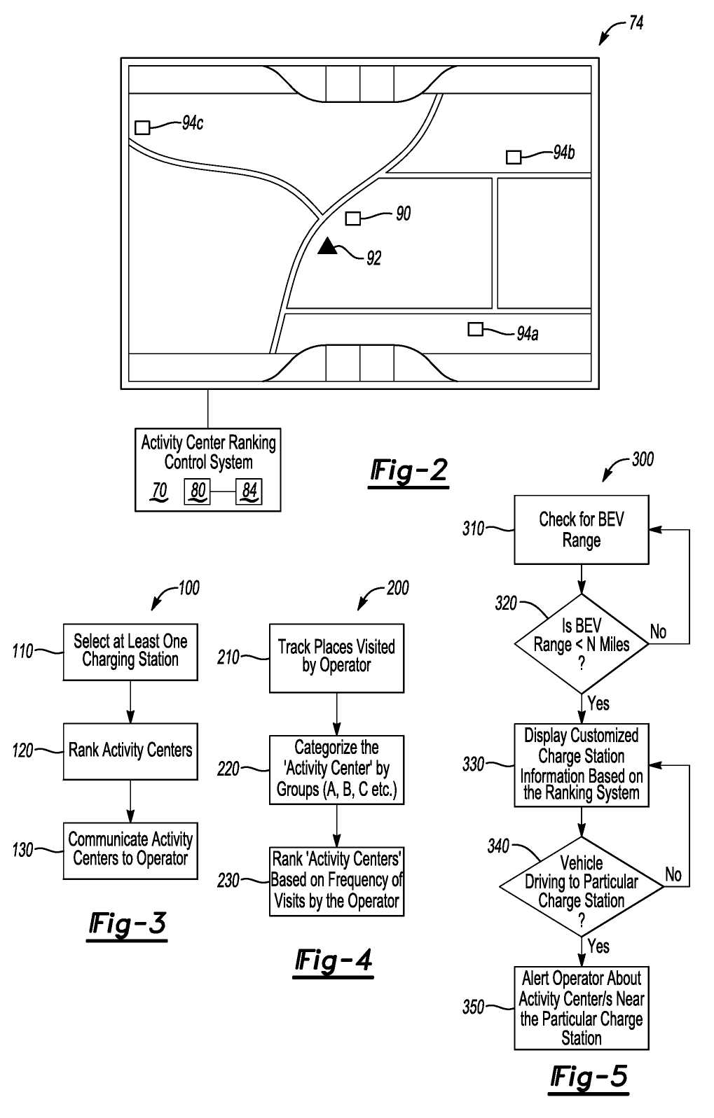

Referring now to FIG. 2 with continuing reference to FIG. 1, the example electrified vehicle 10 includes an activity center ranking control (ACRC) system 70 operatively connected to a user interface display 74 within a passenger compartment of the electrified vehicle 10.

The example ACRC system 70 includes a processor 80 and a memory portion 84. The processor 80 is configured to execute a program stored in the memory portion 84 as code. The program can be stored in the memory portion 84 as software code. The program stored in the memory portion 84 can include one or more additional or separate programs, each of which includes an ordered listing of executable instructions for implementing logical functions associated with, for example, ranking activity centers.

The ACRC system 70 may be part of an overall vehicle control system or could be a separate control system that communicates with the vehicle control system. The ACRC system 70 may include one or more control modules equipped with executable instructions for interfacing with and commanding operation of various components of the electrified vehicle 10.

In one non-limiting embodiment, the processor 80 of the ACRC system 70 comprises a central processing unit in communication with the memory portion 84, which can include various types of computer readable storage devices or memory devices for executing the exemplary activity center ranking methods of this disclosure.

The ACRC system 70 is adapted to perform multiple functions. In a first non-limiting embodiment, the ACRC system 70 is configured with the necessary inputs, outputs, control logic and/or algorithms for receiving signals from the various vehicle systems, systems that are external to the vehicle, and to commanding specific actions based on these received signals.

Based on an output from the ACRC system 70, the user interface display 74 represents, on a map, the charging station 50 as a symbol 90, a current location of the electrified vehicle 10 as a symbol 92, and highly ranked activity centers as symbols 94a, 94b, and 94c. An operator of the electrified vehicle 10 can review the user interface display 74 to find out what highly ranked activity centers are near the symbol 92 and thus near the charging station 50.

In this example, the processor 80 of the ACRC system 70 executes a program that ranks activity centers based on activity centers visited in connection with previous charges of the electrified vehicle 10. The ACRC system 70 is thus specialized to rank activity centers.

The activity centers that are ranked can include the activity centers within a threshold distance of the electrified vehicle 10, the charging station 50, or both.

For example, if the threshold distance is within one mile of a charging station, the ACRC system 70 first compiles all activity centers within one mile of the charging station 50. Of those activity centers, the activity centers that are more likely to be visited by the operator are then ranked ahead of the activity centers that are less likely to be visited by the operator. Once the activity centers are ranked, the ACRC system 70 communicates the most highly ranked activity centers to the operator using the user interface display 74.

Example activity centers could be archived as groups of a Table that is held within the memory portion 84 as shown below:

Group A: Coffee place (1), Book store (2), Public Library (3)

Group B: Shopping mall (1), Grocery Shop (2), Movie hall (3), Art fair (4)

Group C: Beauty Salon (1), Fitness/Yoga Center (2), Gift shop (3)

Group D: Places of other interest to BEV driver (Flower Shop (1) etc.).

For each of the Groups A-D, the ACRC system 70 assigns the numbers to the activity centers listed in the Table for ranking purposes. The ranking prioritize the places which were (or may be) visited frequently by the operator. Grouping helps to segregate the activity centers. As more and more activity centers are surveyed, the groups and rankings are revised.

An example ranking for the activity centers in the Table based on frequency of visits may include, A1>C2>B3, B2>D1>B4, C2>A2>D1 etc.

Notably, the ranking can be associated with a location of an associated charging station. Ranking can include distance between the activity centers and the associated charging station as a factor.

The ACRC system 70 tracks, customizes, and stores ranking information for the activity centers along with information about charging station locations. The ACRC system 70 can work together with a navigation system of the electrified vehicle 10 to develop a database of activity centers that are used to populate the Table. The ACRC system 70 can continually update the ranking in response to the operator visiting activity centers, charging stations, or both.

In this example, the three most highly ranked activity centers are represented by symbols 94a, 94b, and 94c. In another example, some other number of highly ranked activity centers are shown, such as two or four. In yet another example, all the activity centers in the display geographical area are shown on the user interface display 74, but the highly ranked activity centers are highlighted relative to the lower ranked activity centers.

Information about the activity centers visited in connection with the previous charges can be stored within the memory portion 84 in a database form. Some or all of the information could be stored outside the electrified vehicle 10, such as within an external cloud-type database.

The stored information can reveal that, after a charge of the electrified vehicle 10, the operator of the electrified vehicle 10 often visits a coffee shop and then a book store. Thus, when charging the electrified vehicle 10 at the charging station 50, activity centers that are coffee shops and book stores are ranked above other types of activity centers.

Some current vehicles can display information about activity centers near a vehicle, but the display of these activity centers is not filtered to display the activity centers most relevant to the operator at the charging station 50.

The user interface display 74 is an activity center reporting device that communicates activity centers to the operator. Another example activity center reporting device could instead, or additionally, incorporate some sort of audible reporting. A speaker, for example, could audibly indicate to the operator that a coffee shop is nearby the charging station 50.

In some examples, the operator selects one of the communicated activity centers—a coffee shop, for example. The ACRC system 70 then provides a planned route for the electrified vehicle 10 from the charging station 50 to the coffee shop.

Referring to FIG. 3 with continuing reference to FIGS. 1 and 2, an example method 100 executed by the ACRC system includes a step 110 of selecting a charging station for the electrified vehicle 10.

After the step 110, the method executes a step 120 that ranks a plurality of activity centers based on what activity centers were visited in connection with previous chargers.

At a step 130, the method communicates at least one of the plurality of activity centers to an operator of the electrified vehicle based on the ranking and proximity to the charging station.

Notably, the selecting of the charging station at the step 110 may not require the vehicle to be at the particular charging station location. Rather, the selection may be a display of a particular charging station within the vehicle.

Referring now to FIG. 4 with continuing reference to FIGS. 1 to 3, an example of the step 120 in the method 100 includes a ranking process 200. At a step 210, the ranking process 200 tracks places (e.g., activity centers) visited by the operator of the electrified vehicle 10. The tracked places can include places visited by the operator when driving the electrified vehicle 10, places visited by the operator when driving another vehicle, or both.

At a step 220, the process 200 categorizes the activity centers by groups. Next, at a step 230, the process 200 ranks the activity centers based on, for example, a frequency of visits by the operator. After the ranking in the step 230, the method 100 can communicate the highest ranked activity centers to the operator at the step 130 as shown in FIG. 3.

Ranking activity centers can be particularly useful if the operator is on an extended trip with the electrified vehicle 10. On such a trip, the operator may be required to charge the electrified vehicle at a new charging station that has not previously been visited by the operation. The operator may thus be unaware of activity centers nearby. Ranking the activity centers near the new charging station based on activity centers visited in connection with previous charges at other charging stations can provide the operator with useful information. Reviewing the activity centers communicated to the operator can occupy the operator's time when charging the electrified vehicle 10 at the charging station 50.

Further, if the operator is driving the electrified vehicle 10 on an extended trip and is presented with a plurality of different charging stations to choose from, the ranking of activity centers proximate to those charging stations may facilitate the operator's selection of a particular charging station. For example, the operator may choose charging station A rather than charging station B because charging station A is closer to more activity centers that are highly ranked according to the program executed on the processor 80.

For example, referring to FIG. 5 with continuing reference to FIGS. 1 and 2, an example extended trip method 300 can include a step 310 that check a BEV range for the electrified vehicle 10. The BEV range represents an estimated distance that the electrified vehicle 10 can travel without recharging the battery 14 at a charging station.

Next, at a step 320, the method 300 calculates whether the BEV range is less than N miles, where N represents a total distance for a trip planned by the operator. If not, the method 300 returns to the step 310. If yes, the method 300 moves to a step 330, which communicates customized charging station information to the operator. In this example, the user interface display 74 is used to communicate the information. The step 330 could, in some examples, only display charging stations having highly ranked activity centers nearby.

The method 300 then assesses whether the electrified vehicle 10 is being driven to a particular charging station at a step 340. If not, the method 300 returns to the step 340. If so, the method 300 moves to the step 350, which communicates activity centers that are near the particular charging station. The communicated activity centers include the highly ranked activity centers. For example, the top three ranked activity centers near the particular charging station could be communicated to the operator in the step 350. Reviewing the activity centers communicated in the step 350 could engage the driver when waiting to charge or when charging the electrified vehicle 10 at the particular charging station.

Features of the disclosed examples include providing an operator of an electrified vehicle with relevant, customized information in connection with charging the electrified vehicle. The customized information about activity centers can enhance the operator's experience with the electrified vehicle by, among other things, helping the operator to decide which charging station to use for charging the electrified vehicle. The customized information can also help the operator decide how to occupy the downtime associated with charging the electrified vehicle.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

What is claimed is:

1. An activity center ranking method, comprising:
ranking a plurality of activity centers based on what activity centers were visited in connection with previous charges; and
communicating at least one of the plurality of activity centers to an operator of an electrified vehicle based on the ranking and proximity to a charging station.

2. The method of claim 1, comprising receiving a selection of one of the plurality of activity centers, and planning a route for the electrified vehicle from the charging station to the one of the plurality of activity centers.

3. The method of claim 1, comprising ranking the plurality of activity centers based additionally on a driving history of the operator.

4. The method of claim 1, comprising ranking the plurality of activity centers based additionally on a profile of the operator.

5. The method of claim 1, comprising communicating the at least one activity center using a display.

6. The method of claim 1, comprising communicating the at least one activity center using an audible alert.

7. The method of claim 1, comprising ranking the plurality of activity centers based on what activity centers were visited by the operator during previous charges of the electrified vehicle.

8. The method of claim 1, comprising ranking the plurality of activity centers based on what activity centers were visited during a threshold time period after previous charges of the electrified vehicle.

9. The method of claim 1, comprising ranking the plurality of activity centers based on what activity centers were visited by the operator in connection with previous charges of another electrified vehicle.

10. The method of claim 1, comprising ranking the plurality of activity centers based on what activity centers were visited in connection with previous charges of the electrified vehicle.

11. The method of claim 1, wherein the charging station is a charging station that has not previously charged the electrified vehicle.

12. The method of claim 6, wherein the ranking is based on a frequency of visits to a type of activity center.

13. The method of claim 12, wherein the ranking is additionally based on a profile of the operator.

14. An electrified vehicle system, comprising:
an activity center ranking control system configured to execute a program that ranks a plurality of activity centers based on activity centers visited in connection with charges of an electrified vehicle; and
an activity center reporting device configured to communicate at least one of the activity centers based on the ranking and proximity to a charging station used to charge the electrified vehicle.

15. The system of claim 14, wherein the activity center reporting device comprises a display within the electrified vehicle.

16. The system of claim 14, wherein the program further ranks the plurality of activity centers based on an operator of the electrified vehicle.

17. The system of claim 14, wherein the program further ranks the plurality of activity centers based on what activity centers were visited by the operator during previous charges of the electrified vehicle.

18. The system of claim 14, wherein the program further ranks the plurality of activity centers based on what activity centers were visited during a threshold time period after previous charges of the electrified vehicle.

19. The system of claim 14, wherein the program further ranks based on what activity centers were visited by the operator in connection with previous charges of another electrified vehicle.

20. The system of claim 14, wherein the charging station is a charging station that has not previously charged the electrified vehicle.
